(19) United States
(12) Patent Application Publication
(10) Pub. No.: US 2014/0017163 A1
(43) Pub. Date: Jan. 16, 2014

(54) METHOD OF PREPARING SN-BASED OXIDE SEMICONDUCTOR NANOPOWDER AND METHOD OF MANUFACTURING PHOTOELECTRIC ELECTRODE USING SN-BASED OXIDE SEMICONDUCTOR NANOPOWDER

(71) Applicants: Kug Sun Hong, Seoul (KR); Seong Sik Shin, Seoul (KR); Jae Ho Suk, Seoul (KR); Sang Baek Park, Seoul (KR); Jong Hoon Park, Seoul (KR); In Sun Cho, Namyangju-si (KR); Dong Wook Kim, Seongnam-si (KR)

(72) Inventors: Kug Sun Hong, Seoul (KR); Seong Sik Shin, Seoul (KR); Jae Ho Suk, Seoul (KR); Sang Baek Park, Seoul (KR); Jong Hoon Park, Seoul (KR); In Sun Cho, Namyangju-si (KR); Dong Wook Kim, Seongnam-si (KR)

(73) Assignee: SNU R&DB FOUNDATION, Seoul (KR)

(21) Appl. No.: 13/546,833

(22) Filed: Jul. 11, 2012

(30) Foreign Application Priority Data
Jul. 11, 2012 (KR) 10-2012-0075415

(51) Int. Cl. C01F 11/02

(52) U.S. Cl. 423/594.9

(57) ABSTRACT

Disclosed herein is a method of preparing a ternary oxide semiconductor compound, including the steps of: dissolving an inorganic salt source including Sn and an inorganic salt source including at least one selected from the alkali earth metal group consisting of Ba, Sr and Ca in a mixed solvent of water and hydrogen peroxide to form a mixed solution; precipitating the mixed solution by changing the PH thereof to obtain a precipitate and then aging the precipitate; and drying and then annealing the aged precipitate to prepare MSnO₃ powder (here, M includes at least one selected from the group consisting of Ba, Sr and Ca). The method is advantageous in that a nanosized ternary oxide semiconductor compound having a uniform particle size distribution can be prepared.

### BACKGROUND OF THE INVENTION

1. Technical Field

The present invention relates to a method of preparing Sn-based oxide semiconductor nanopowder, and, more particularly, to a method of preparing Sn-based ternary oxide semiconductor nanopowder for a photoelectric electrode.

2. Description of the Related Art

Multi-component oxide semiconductor nanopowder is practically used in the various industrial fields of various kinds of sensors, solar cells, etc.

Conventional multi-component oxide semiconductor nanopowder is generally prepared by a hydrothermal synthesis method that uses heat and high pressure. However, this method is problematic in that high-priced equipment is needed and a very small amount of nanopowder is prepared.

Further, this method is problematic in that very large powder having a non-uniform particle size is obtained because the growth rate of the intermediates occurring during a reaction cannot be controlled. For example, in the hydrothermal synthesis of BaSnO₃ oxide semiconductor powder, BaSn(OH)₆ is formed as an intermediate of BaSnO₃. This intermediate is characterized in that its growth rate is very rapid and its particle size is very non-uniform.

Meanwhile, a dye-sensitized solar cell uses the principle that, when a semiconductor oxide electrode, on the surface of which dye molecules are chemically adsorbed, absorbs solar light, dye molecules donate electrons, and these electrons are transferred to a transparent conductive substrate along several routes, thus finally producing electric current. The dye-sensitized solar cell is advantageous in that its manufacturing process is simple and its stability is very high compared to conventional silicon solar cells, and in that it is a little influenced by the amount of solar light compared to silicon-based solar cells.

The anode of the dye-sensitized solar cell includes a transparent conductive film formed on a glass substrate, and an oxide semiconductor film made of oxide semiconductor nanoparticles such as TiO₂ nanoparticles. The oxide semiconductor film is provided thereon with a dye polymer by adsorption or the like. The cathode (counter electrode or opposite electrode) of the dye-sensitized solar cell is generally made of platinum or the like, and is provided on a glass substrate. An electrolyte is provided between the anode and the cathode.

The general operating principle of the dye-sensitized solar cell is as follows. That is, when solar light is incident on the dye sensitized solar cell, a dye polymer is excited to form an electron-hole pair, and the electron is injected into a conduction band of a semiconductor oxide. The injected electron passes through the semiconductor oxide and simultaneously transfers electric energy to the outside. The electron, which transferred electric energy to the outside, is bonded with the hole of the dye polymer in the counter electrode by the oxidation-reduction reaction of an electrolyte.

The photoelectric effect attributable to dye has been continuously researched since it was reported by Doctor Moser of Vienna University in 1887. Currently, there is being researched a dye-sensitized solar cell that uses an Ru-based dye and an I⁻/I₃⁻ electrolyte and has a high efficiency of 10% or more (less than 20%), commonly called “Gratzel cell”, which was reported by the study group of Professor Gratzel of the Ecole Polytechnique Federale in 1991.

Therefore, in order to absorb a large amount of dye, it is required to use an oxide semiconductor photoelectric electrode having a large specific surface area as the dye-adsorbed photoelectric electrode. Conventionally, TiO₂ has been generally used as the raw material of a photoelectric electrode, but, to date, the maximum efficiency of the photoelectric electrode using TiO₂ is only 11%. Accordingly, it is required to develop a new oxide semiconductor photoelectric electrode material.

### PRIOR ART DOCUMENTS

### Patent Documents

Korean Unexamined Patent Publication No. 2009-62838

Korean Unexamined Patent Publication No. 2003-90936

U.S. Pat. No. 4,911,914

European Patent No. 0333103

### SUMMARY OF THE INVENTION

Accordingly, the present invention has been devised to solve the above-mentioned problems, and an object of the present invention is to provide a method of preparing a novel ternary oxide semiconductor nanopowder.

Another object of the present invention is to provide a method of preparing a ternary oxide semiconductor nanopowder having a controllable and uniform particle size of several tens of nanometers.

Still another object of the present invention is to provide a method of manufacturing a ternary oxide semiconductor film using the above ternary oxide semiconductor nanopowder, wherein the ternary semiconductor film replaces a conventional TiO₂ film and has excellent dye adsorption characteristics.

Still another object of the present invention is to provide a method of manufacturing a novel ternary oxide semiconductor film, by which the photoelectric energy conversion efficiency of a dye-sensitized solar cell increases compared to that of a conventional ternary oxide semiconductor film.

In order to accomplish the above objects, an aspect of the present invention provides a method of preparing a ternary oxide semiconductor compound, including the steps of: dissolving an inorganic salt source including Sn and an inorganic salt source including at least one selected from the alkali earth metal group consisting of Ba, Sr and Ca in a mixed solvent of water and hydrogen peroxide to form a mixed solution; precipitating the mixed solution by changing the PH thereof to obtain a precipitate and then aging the precipitate; and drying and then annealing the aged precipitate to prepare MSnO₃ powder (here, M includes at least one selected from the group consisting of Ba, Sr and Ca).

In the method, the mixed solvent may further include citric acid or ascorbic acid.

Further, the pH of the mixed solution may be changed by using ammonia or sodium hydroxide.

Further, in the mixed solvent of water and hydrogen peroxide, the concentration of hydrogen peroxide may be 10˜35%.

Further, the MSnO₃ powder may have a particle size of 50 nm or less.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a method of preparing Sn-based ternary oxide semiconductor nanopowder according to an embodiment of the present invention;

FIG. 2 is an electron microscope photograph of BaSnO₃ prepared according to an embodiment of the present invention;

FIG. 3 is a graph showing the X-ray diffraction pattern of BaSnO₃ prepared according to an embodiment of the present invention;

FIG. 4 is an electron microscope photograph of a BaSnO₃ film manufactured according to an embodiment of the present invention;

FIG. 5 is a graph showing the X-ray diffraction pattern of a BaSnO₃ film manufactured according to an embodiment of the present invention; and

FIG. 6 is a graph showing the I-V characteristics of a dye-sensitized solar cell including the BaSnO₃ film manufactured according to an embodiment of the present invention.

### DESCRIPTION OF THE PREFERRED EMBODIMENTS

Hereinafter, preferred embodiments of the present invention will be described in detail with reference to the attached drawings.

The present invention provides a method of preparing multi-component oxide semiconductor powder represented by the following Formula 1:

MSnO₃ (1)

(here, M includes at least one selected from the group consisting of Ba, Sr and Ca).

A. Preparation of Sn-Based Ternary Oxide Semiconductor Nanopowder

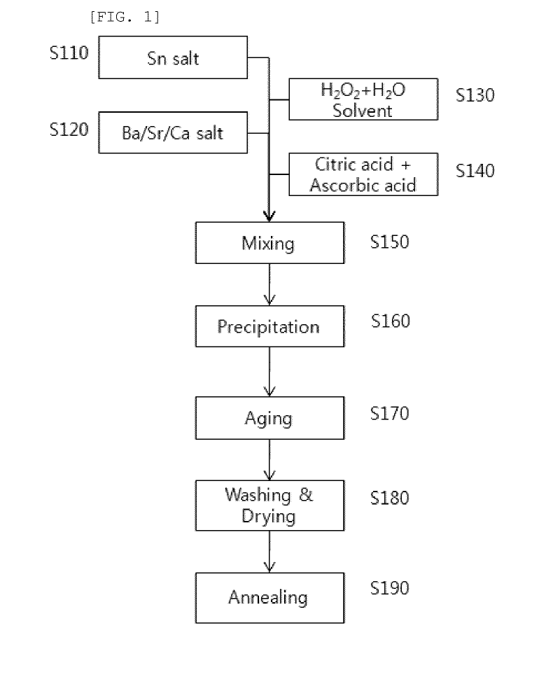

FIG. 1 is a schematic view showing a method of preparing Sn-based ternary oxide semiconductor nanopowder according to an embodiment of the present invention.

Referring to FIG. 1, an inorganic salt source including Sn, such as SnCl₄, and an inorganic salt source including at least one selected from the alkali earth metal (M) group consisting of Ba, Sr and Ca are dissolved in a mixed solvent of water and hydrogen peroxide.

That is, the inorganic salt sources are dissolved in hydrogen peroxide water. As the hydrogen peroxide water, 30% hydrogen peroxide water may be used. Further, the inorganic salt sources may be mixed such that the molar ratio of Sn:M is 1:1.

Generally, when the inorganic salt sources are reacted in water with ammonia, MSn(OH)₆ is formed as an intermediate, and this intermediate is rapidly reacted to form large particles of 1 um or more. However, when the inorganic salt sources are reacted in hydrogen peroxide water, MSn(O₂)O₂-3H₂O is formed as an intermediate while inhibiting the formation of MSn(OH)₆. The particle size of this intermediate is easily controlled.

Subsequently, citric acid or ascorbic acid is added to the mixed solvent, and then the inorganic salt sources are dissolved in this mixed solvent to form a mixed solution. In this case, it is preferred that the pH of the mixed solution be 9˜11.

As described later, in the present invention, citric acid or ascorbic acid functions to prevent primary particles of 2˜30 nm from agglomerating.

Subsequently, the mixed solution is precipitated at room temperature by using ammonia water or sodium hydroxide, and is then stirred and aged for 1˜20 hours to obtain a precipitate.

Subsequently, the obtained precipitate is washed and then dried. In the present invention, the precipitate may be dried by a general drying method such as freeze drying. The dried powder is reacted at a temperature of 500˜950° C. to synthesize MSnO₃.

### Example 1

3.577 g of SnCl₄-5H₂O and 2.467 g of BaCl₂-2H₂O were dissolved in 170 mL of 30% hydrogen peroxide water (volume ratio of water and hydrogen peroxide was 70:30) to form a mixed solution. Subsequently, the mixed solution was precipitated by adding 120 mL of ammonia water to the mixed solution such that the pH of the mixed solution was 9˜11, and was then aged for 12 hours to obtain a precipitate. Subsequently, the obtained precipitate was washed, freeze-dried, and then annealed at a temperature of 900° C. for about 2 hours to prepare BaSnO₃ powder.

### Example 2

3.577 g of SnCl₄-5H₂O and 2.467 g of BaCl₂-2H₂O were dissolved in 170 mL of 30% hydrogen peroxide water to form a first mixed solution. Subsequently, 1 g of citric acid or 1 g of ascorbic acid was added to the first mixed solution to form a second mixed solution. Subsequently, the second mixed solution was processed in the same manner as in Example 1. That is, the second mixed solution was precipitated by adding ammonia water, and was then aged for 12 hours to obtain a precipitate. Subsequently, the obtained precipitate was washed, freeze-dried, and then annealed to prepare BaSnO₃ powder.

### Example 3

3.577 g of SnCl₄-5H₂O and 2.467 g of BaCl₂-2H₂O were dissolved in 170 mL of 30% hydrogen peroxide water to form a mixed solution. Subsequently, the mixed solution was processed in the same manner as in Example 1. That is, the mixed solution was precipitated by adding 120 mL of ammonia water, and was then aged, dried and then annealed to synthesize BaSnO₃ powder.

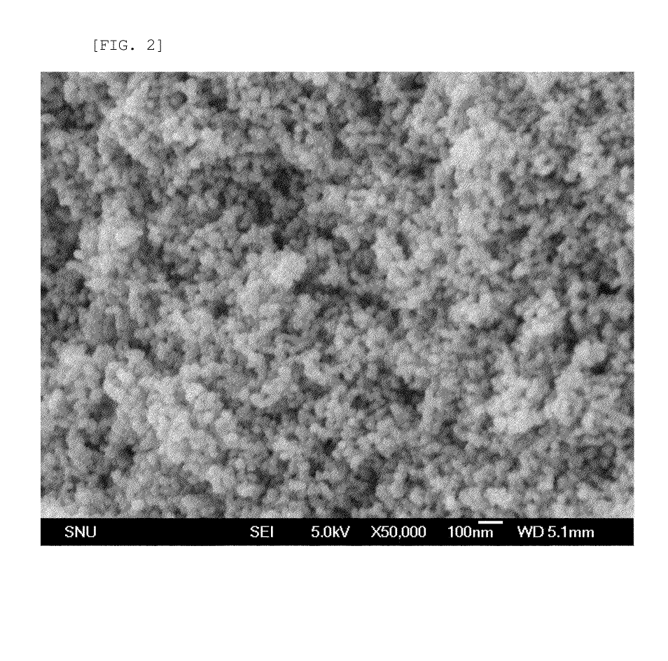

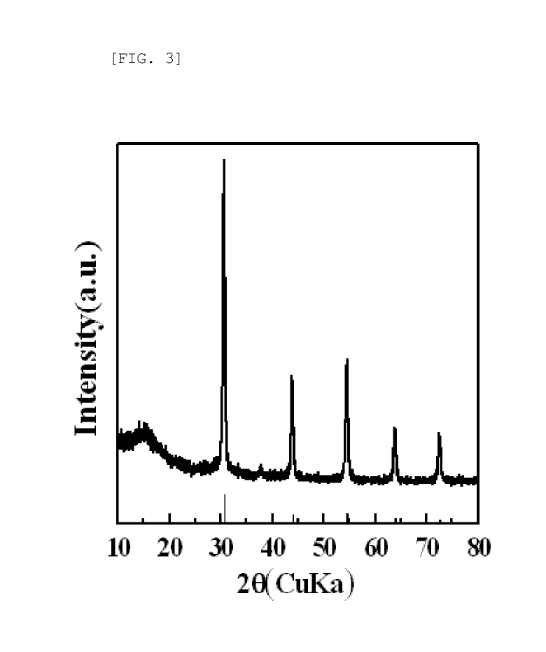

FIG. 2 is an electron microscope photograph of BaSnO₃ powder prepared according to Example 2, and FIG. 3 is a graph showing the X-ray diffraction pattern of BaSnO₃ powder prepared according to Example 2.

As shown in FIG. 2, it can be seen that the prepared BaSnO₃ powder is composed of uniform size particles of several tens of nanometers (average particle size: 25 nm).

Meanwhile, in the case of Example 1, the primary particle size of the prepared BaSnO₃ powder was several tens of nanometers. However, thereafter, particles were agglomerated, and thus the particle size of the agglomerated BaSnO₃ powder reached a level of 100˜400 nm (average particle size: 300 nm).

Meanwhile, in the case of Example 3, it was ascertained that particles were rapidly grown, thus forming rough and large particles of 1 μm or more (average particle size: 2 μm).

B. Manufacturing of an Sn-Based Ternary Oxide Semiconductor Film

The prepared BaSnO₃ powder was mixed with a solution including terpineol and ethyl cellulose, each of which is organic matter, to form paste, and then the paste was applied onto an FTO substrate by screen printing to form a primary film. Subsequently, the primary film was heat-treated at 500° C. for 1 hour to remove organic matter therefrom, thereby forming a BaMO₃ film.

C. Evaluation of Dye Adsorption Performance of an Sn-Based Ternary Oxide Semiconductor Film

An MSnO₃ film having prescribed thickness was formed on a substrate, and then the MSnO₃ film was dipped into a solution prepared by dissolving a dye (ruthenium-based N719 dye (cis-diisothiocyanato-bis(2,2′-bipyridyl-4,4′-dicarboxylato) ruthenium(II) bis(tetrabutylammonium)) in ethanol to a concentration of 0.05 nM for a predetermined amount of time, thus allowing the MSnO₃ film to adsorb the dye.

The MSnO₃ film adsorbing the dye was immersed into a mixed solution (ammonia 10 cc+distilled water 50 cc+ethanol 50 cc), in which ammonia, distilled water and ethanol were mixed in a volume ratio of 1:5:5, and then the dye was desorbed from the MSnO₃ film for about 20 minutes. Subsequently, the absorbance of the mixed solution using a UV-visible spectrometer was measured to calculate the amount of the dye desorbed from the MSnO film.

D. Evaluation of Characteristics of an Sn-Based Ternary Oxide Semiconductor Film

A dye-sensitized solar cell was fabricated using the FTO substrate provided with the MSnO₃ film as a working electrode. In this case, the cathode (counter electrode or opposite electrode) of the dye-sensitized solar cell was formed by sputtering platinum (Pt) on a glass substrate. The counter electrode formed in this way and the working electrode provided with the MSnO₃ film were packed in the form of a sandwich to form a cell, and then an iodine-based electrolyte was injected into the packed cell.

The I-V characteristics of the fabricated dye-sensitized solar cell were measured. The I-V characteristics thereof were measured using a solar simulator based on AM1.5 (100 mW/cm²) in a voltage range of −0.1˜0.9 V, which were measured by a potentiostat manufactured by CHI Instrument Co., Ltd.

### Example 4

BaSnO₃ nanopowder having an average particle size of about 25 nm was prepared, and then an FTO substrate was coated with the BaSnO₃ nanopowder to form a BaSnO₃ film having prescribed thickness. In this case, the area of the BaSnO₃ film was 0.25 cm². The BaSnO₃ film was dipped into a dye and then the dye was desorbed therefrom to evaluate the dye adsorption performance of the BaSnO₃ film. A dye-sensitized solar cell was fabricated using the BaSnO₃ film as a working electrode, and then the I-V characteristics thereof were evaluated.

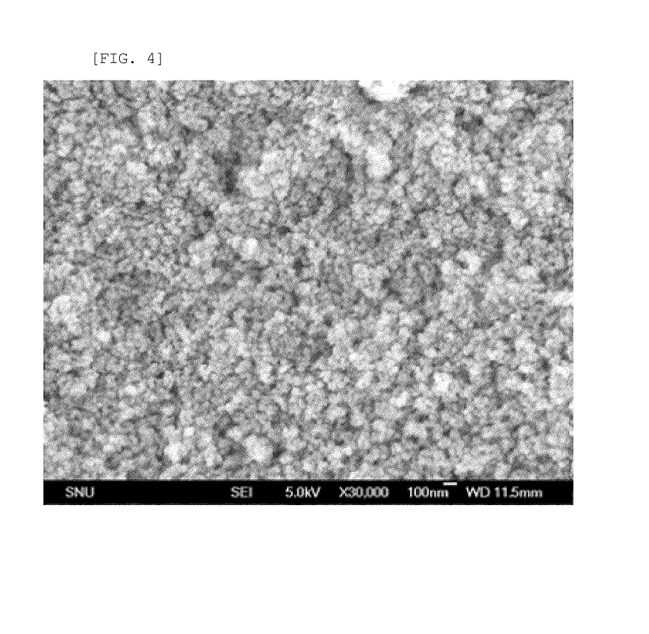

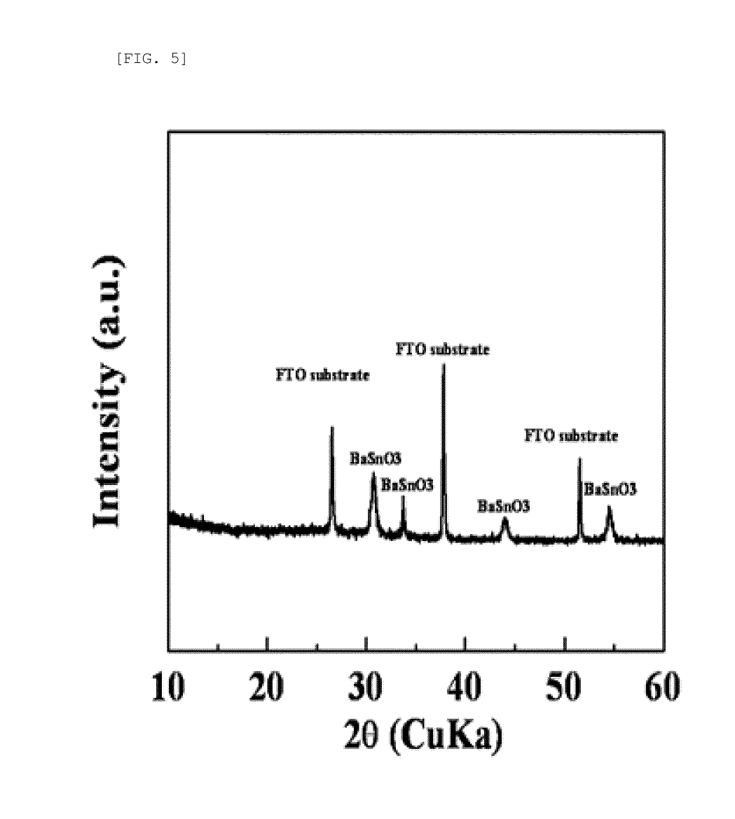

FIG. 4 is an electron microscope photograph of the BaSnO₃ film prepared according to Example 4, and FIG. 5 is a graph showing the X-ray diffraction pattern of the BaSnO₃ powder prepared according to Example 4.

Referring to FIGS. 4 and 5, it can be seen that a BaSnO₃ film having a uniform particle size of several tens of nanometers was formed.

### Example 5

A BaSnO₃ film was formed, the dye adsorption performance of the BaSnO₃ film was evaluated and the I-V characteristics of the dye-sensitized solar cell fabricated using the BaSnO₃ film were evaluated in the same manner as in Example 4, except that BaSnO₃ nanopowder having an average particle size of 300 nm was used.

### Example 6

A BaSnO₃ film was formed, the dye adsorption performance of the BaSnO₃ film was evaluated and the I-V characteristics of the dye-sensitized solar cell fabricated using the BaSnO₃ film were evaluated in the same manner as in Example 4, except that BaSnO₃ nanopowder having an average particle size of 2 μm was used.

### Comparative Example 1

A TiO₂ film formed of TiO₂ nanopowder having an average particle size of about 25 nm was dipped into a dye for 12 hours and then the dye was desorbed therefrom to evaluate the dye adsorption performance of the TiO₂ film. A dye-sensitized solar cell was fabricated using the TiO₂ film as a working electrode, and then the I-V characteristics thereof were evaluated. In this case, Comparative Example 1 was carried out in the same manner as in Example 4, except that a TiO₂ film was used instead of a BaSnO₃ film.

The results of evaluating the dye adsorption performance of the films of Examples 4 to 6 and Comparative Example 1 are given in Table 1 below.

TABLE 1

| | Film | Dipping | Desorbing | |
|---|---|---|---|---|
| Class. | Thickness | time | time | Amount of dye |
| Example 4 | 12 μm | 20 min | 20 min | 2.4*10⁻⁷ mol/cm² |
| | 30 μm | 40 min | 20 min | 5.14*10⁻⁷ mol/cm² |
| Example 5 | 12 μm | 1 h | 20 min | 1.9*10⁻⁷ mol/cm² |
| Example 6 | 12 μm | 1 h | 20 min | 1.78*10⁻⁷ mol/cm² |
| Comp. | 12 μm | 12 hours | 20 min | 1.1*10⁻⁷ mol/cm² |
| Example 1 | 30 μm | 12 hours | 20 min | 2.02*10⁻⁷ mol/cm² |

Referring to Table 1 above, in the case of Examples 4 to 6, it can be seen that dye was adsorbed in an amount of 1*10⁻⁷ mol/cm² or more although dipping time was under 1 h, which was short. From the results, it can be ascertained that the dye adsorption performance of the films of Examples 4 to 5 was remarkably excellent compared to that of a TiO₂ film. For example, a TiO₂ film is generally known to require a dye adsorbing time of 12˜24 hours in order to allow a dye-sensitized solar cell to exhibit its own performance. Moreover, it can be seen that the amount of dye adsorbed in the TiO₂ film is far smaller than that of dye adsorbed in the BaSnO₃ film although the TiO₂ film has a particle size (specific surface) corresponding to long dye adsorbing time.

Meanwhile, in Examples 4 to 6, it can be seen that the total amount of dye adsorbed in the BaSnO₃ film increases depending on the decrease in particle size. Particularly, when the average particle size is 100 nm or more (Examples 5 and 6), there is only a small difference in the amount of dye adsorbed in the BaSnO₃ film depending on the particle size. However, when the average particle size is less than 100 μm, the amount of dye adsorbed in the BaSnO₃ film exceeds 2*10⁻⁷ mol/cm², and simultaneously the dye adsorption characteristics of the BaSnO₃ film rapidly improve.

Since the BaMO₃ film, including a BaSnO₃ film, of the present invention has a perovskite structure and includes many OH functional groups on the surface thereof, it exhibits excellent dye adsorption characteristics. The OH functional groups help the BaMO₃ film to adsorb dye, and thus the BaMO₃ film adsorbs a very large amount of dye compared to the conventional TiO₂ film.

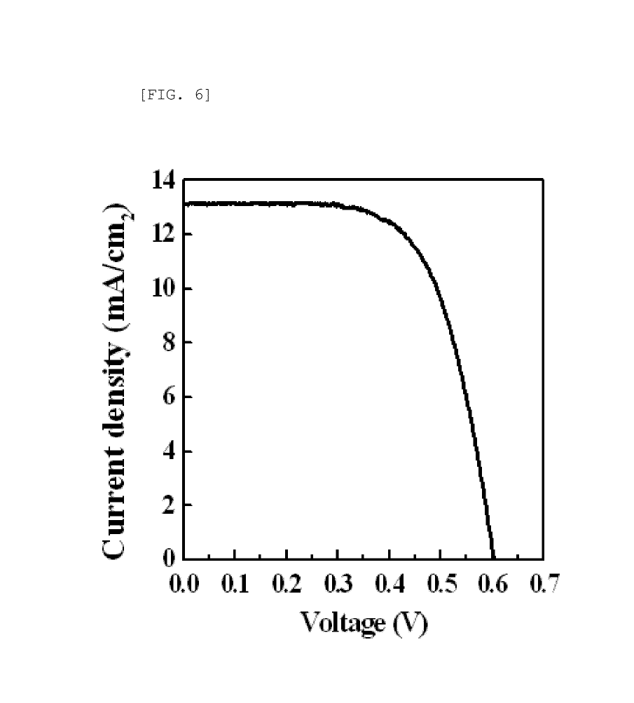

FIG. 6 is a graph showing the I-V characteristics of a dye-sensitized solar cell including the BaSnO₃ film manufactured according to Example 4.

Further, the results of evaluating the photoelectric energy conversion efficiency of the dye-sensitized solar cells of Examples 4 to 6 and Comparative Example 1 are given in Table 2 below.

TABLE 2

| | Photoelectric energy |
|---|---|
| Classification | conversion efficiency |
| Example 4 | 5.2% |
| Example 5 | 1.5% |
| Example 6 | 0.7% |
| Comp. Example 1 | 4.5% |

From Table 2 above, it can be seen that the photoelectric energy conversion efficiency of the BaSnO₃ film of Example 4 was made higher than that of the TiO₂ film of Comparative Example 1 by about 0.7%. Further, it can be seen that the photoelectric energy conversion efficiency of the BaSnO₃ film of Examples 4 to 5 increased from 0.7% to 5.2% depending on the decrease in the particle size of the BaSnO₃ film.

As described above, according to the present invention, there is provided uniform-nanosized ternary oxide semiconductor powder.

Further, since the ternary oxide semiconductor powder has uniform dispersion characteristics, it is possible to prevent particles from agglomeration during a film forming process, thus providing an oxide semiconductor film having high specific surface area.

In particular, the ternary oxide semiconductor nanopowder of the present invention is suitably used as a raw material of a photoelectric electrode of a dye-sensitized solar cell.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing a ternary oxide semiconductor compound, comprising the steps of:
dissolving an inorganic salt source including Sn and an inorganic salt source including at least one selected from the alkali earth metal group consisting of Ba, Sr and Ca in a mixed solvent of water and hydrogen peroxide to form a mixed solution;
precipitating the mixed solution by changing a PH thereof to obtain a precipitate and then aging the precipitate; and
drying and then annealing the aged precipitate to prepare MSnO₃ powder (here, M includes at least one selected from the group consisting of Ba, Sr and Ca).

2. The method of claim 1, wherein the mixed solvent further includes citric acid or ascorbic acid.

3. The method of claim 2, wherein the mixed solvent has a pH of 9˜11.

4. The method of claim 1, wherein the pH of the mixed solution is changed by adding ammonia or sodium hydroxide.

5. The method of claim 1, wherein, in the mixed solvent of water and hydrogen peroxide, a concentration of hydrogen peroxide is 10˜35%.

6. The method of claim 1, wherein the MSnO₃ powder has a particle size of 50 nm or less.
